(19) United States
(12) Patent Application Publication
(10) Pub. No.: US 2009/0124158 A1
(43) Pub. Date: May 14, 2009

(54) SYSTEM FOR ATTACHING DISPLAY PANEL FOR STEREOSCOPIC IMAGE

(76) Inventor: Jae Seok HWANG, Scongnam-si (KR)

Correspondence Address: KED & ASSOCIATES, LLP, P.O. Box 221200, Chantilly, VA, 20153-1200, US

(21) Appl. No.: 12/268,055

(22) Filed: Nov. 10, 2008

(30) Foreign Application Priority Data
Nov. 9, 2007 (KR) 10-2007-0114487

(51) Int. Cl. H01J 9/46; H01J 9/20

(52) U.S. Cl. 445/24; 445/66

(57) ABSTRACT

A system for attaching a display panel and a stereoscopic lens panel is provided. The system may include a panel supply device that receives a display panel and a stereoscopic lens panel, and a conveyance device that conveys the display panel and the stereoscopic lens panel. A cleaning device cleans attachment surfaces of the display panel and stereoscopic lens panel, and a laminating device laminates an adhesive film onto an attachment surface of the display panel. A panel attachment device then attaches the display panel and the stereoscopic lens panel, either of which may be laminated with the adhesive film by the laminating device, and a baking device bakes the adhesive film interposed between the display panel and the stereoscopic lens panel to form a stereoscopic display panel. A panel discharge device then loads the stereoscopic display panel thereon for subsequent processing.

This application claims priority to Korean Patent Application No. KR 114487/2007, filed in Korea on Nov. 9, 2007, the entirety of which is incorporated herein by reference.

### BACKGROUND

1. Field

A system which can attach a stereoscopic lens panel to a display panel is provided.

2. Background

Development of display devices capable of displaying stereoscopic images is ongoing. Improvements in the manufacture of these types of display devices would reduce cost, improve device quality, and enhance the stereoscopic image displayed by such a device.

### BRIEF DESCRIPTION OF THE DRAWINGS

Embodiments will be described in detail with reference to the following drawings in which like reference numerals refer to like elements, and wherein:

FIG. 1 is a perspective view of a system for attaching panels of a stereoscopic display panel in accordance with an embodiment as broadly described herein.

FIG. 2 is a sectional view of an ultrasonic cleaning device of the system shown in FIG. 1.

FIG. 3 is a sectional view of a laminating device of the system shown in FIG. 1.

FIG. 4 is a sectional view of a panel attachment device of the system shown in FIG. 1.

FIG. 5 is a sectional view of a baking device of the system shown in FIG. 1.

FIG. 6 is a flow chart showing a procedure of attaching a display panel for stereoscopic image in accordance with embodiments as broadly described herein.

FIGS. 7 through 10 are sectional views sequentially illustrating the operations of the panel attachment device shown in FIG. 4.

### DETAILED DESCRIPTION

Display techniques that allow stereoscopic images to be displayed and viewed may include a stereoscopic system that requires a viewing aid, such as, for example, special glasses, and an autostereoscopic system that does not require such a viewing aid.

In the autostereoscopic system, a display device may include a stereoscopic lens panel having a cylindrical lenticular lens arranged therein and attached to a display panel such as, for example, an LCD (liquid crystal display) panel, or other panel as appropriate. In this type of application, one lenticular lens may include two LCD elements. The light emitted from the two LCD elements may be separated and respectively directed to both eyes of a viewer so that the viewer can recognize the stereoscopic image.

In order to manufacture this type of display panel, various equipments such as, for example, an attachment device that attaches a display panel and a stereoscopic lens panel, a conveyance device that conveys the display panel and the stereoscopic lens into the attachment device, and so forth, may be needed. Efficient arrangement and management of the respective equipments may enhance the manufacturing process.

In certain embodiments, the display panel and the stereoscopic lens panel may be attached through partial application of an adhesive. However, during this process, bubbles may be formed in the adhesive. Bubbles formed in this way may cause scattering of light, degrading the quality of the display panel.

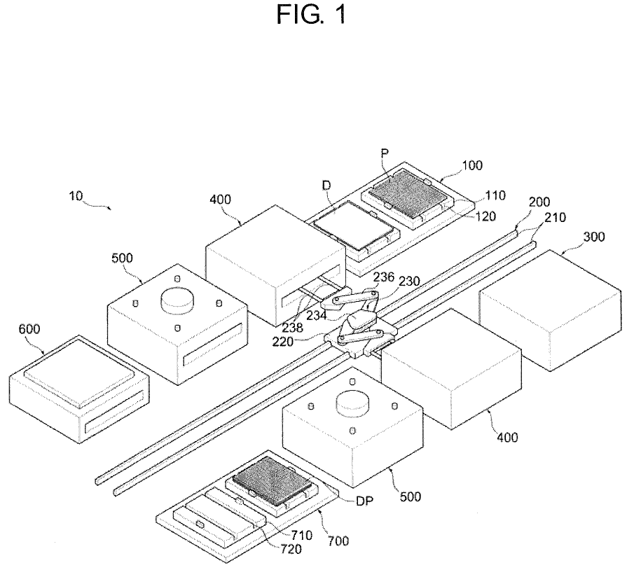

Referring to FIG. 1, a system 10 for attaching a display panel D and a stereoscopic lens panel P may include a panel supply device 100 to which a separately manufactured display panel D and stereoscopic lens panel P may be supplied. A conveyance device 200 may convey the display panel D and the stereoscopic lens panel P from the panel supply device 100 to positions where respective processes may be conducted. A cleaning device 300 may clean respective attachment surfaces of the display panel D and the stereoscopic lens panel P. A laminating device 400 may laminate an adhesive film T on the display panel D cleaned by the cleaning device 300. A panel attachment device 500 may attach the display panel D, having the adhesive film T laminated thereon by the laminating device 400, to the stereoscopic lens panel P. A baking device 600 may bake the adhesive film T interposed between the attached display panel D and stereoscopic lens panel P, and a panel discharge device 700 may discharge the completed stereoscopic display panel DP, having undergone the attaching procedure, for subsequent processing.

In the system 10 shown in FIG. 1, since a plurality of devices (for example, the cleaning device 300, the laminating device 400, the panel attachment device 500, the baking device 600, etc.) are located within a working radius of the single conveyance device 200, the attaching procedure may be continuously conducted as a plurality of display panels D and a plurality of stereoscopic lens panels P are sequentially conveyed to the respective devices. In certain embodiments, the numbers of the respective devices can be increased or decreased as necessary.

Referring to FIG. 1, the panel supply device 100 may be a device on which the display panel D and the stereoscopic lens panel P supplied from a source outside of the attachment system 10 may be temporarily loaded. The panel supply device 100 may include a plurality of loading devices 110 that receive the display panel D and the stereoscopic lens panel P. Insertion grooves 120 that receive the conveyance device 200 may be formed on the upper surface of each loading devices 110. The numbers of the panel supply device 100 and the loading devices 110 may be increased or decreased based on the scale of the attachment system 10.

The conveyance device 200 not only conveys the display panel D and the stereoscopic lens panel P loaded on the panel supply device 100 to the respective devices (for example, the cleaning device 300, the laminating device 400, the panel attachment device 500, and so forth), but may also convey the completed stereoscopic display panel DP, having undergone the attaching procedure, to the panel discharge device 700.

The conveyance device 200 may include rails 210 which extend between the respective devices 100, 300, 400, 500, 600 and 700, a base 220 which reciprocates along the rails 210, and a conveying arm 230 which is installed on the base 220 and which may move integrally with the base 220. At least one conveying arm 230 may be provided, depending upon the arrangement of the respective devices 100, 300, 400, 500, 600 and 700. The conveying arm 230 may include a raising and lowering shaft (not shown) installed on the base 220, a rotating part 234 provided at an end of the raising and lowering shaft, a plurality of pivot links 236 pivotably installed on the rotating part 234, and forks 238 joined to ends of the pivot links 236 to support the lower surfaces of the respective panels D and P.

The cleaning device 300 may remove foreign substances from the attachment surface of the display panel D on which the adhesive film T will be laminated, and also from the attachment surface of the stereoscopic lens panel P, using ultrasonic waves, or other methods as appropriate.

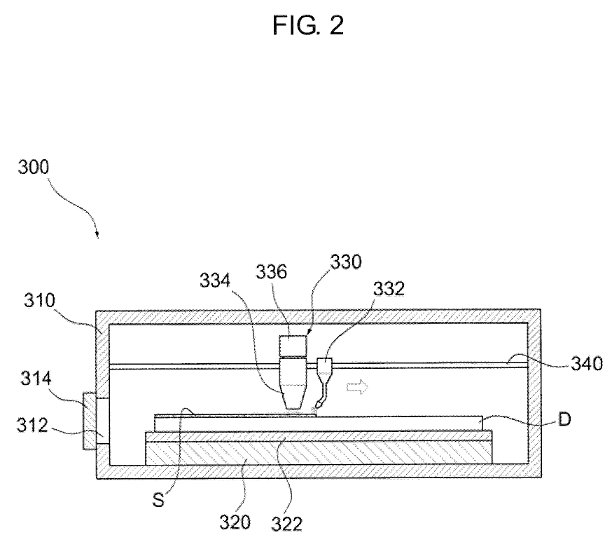

Referring to FIG. 2, the cleaning device 300 may include a cleaning chamber 310 which defines a cleaning space therein. The cleaning chamber 310 may include an opening 312 through which the display panel D or the stereoscopic lens panel P may be introduced into the cleaning space. The cleaning device 300 may also include cleaning stage 320 disposed at a lower portion of the cleaning chamber 310 to allow the display panel D or the stereoscopic lens panel P to be seated thereon, an ultrasonic cleaning device 330 installed above the cleaning stage 320 which may reciprocate to clean the attachment surface of the display panel D or the stereoscopic lens panel P, and guide rails 340 which guide the reciprocating movement of the ultrasonic cleaning device 330.

A separate cleaning door 314 may be provided with the opening 312 so as to selectively close the cleaning space. A cleaning stage fastening device 322 may be provided with the cleaning stage 320 to fasten the display panel D or the stereoscopic lens panel P on the cleaning stage 320. In certain embodiments, the cleaning stage fastening device 322 may be, for example, an electrostatic chuck that uses electrostatic force, a suction chuck that uses vacuum suction force, or other device as appropriate.

The ultrasonic cleaning device 330 may include a cleaning liquid injector 332 which injects a cleaning liquid onto the attachment surface of the display panel D or the stereoscopic lens panel P and forms a cleaning layer S, and an ultrasonic scanner 334 which has an ultrasonic vibrator 336 that generates ultrasonic waves and applies ultrasonic vibrations to the cleaning layer S.

The ultrasonic scanner 334 may be installed on the guide rails 340 so that a gap of about 1˜3 mm is formed with respect to the attachment surface of the display panel D or the stereoscopic lens panel P seated on the cleaning stage 320 such that the ultrasonic scanner 334 may be dipped into the cleaning layer S formed by the cleaning liquid injector 332.

The laminating device 400 may laminate the adhesive film T onto the attachment surface of the display panel D so as to allow the display panel D and the stereoscopic lens panel P to be attached to each other after being cleaned by the cleaning device 300.

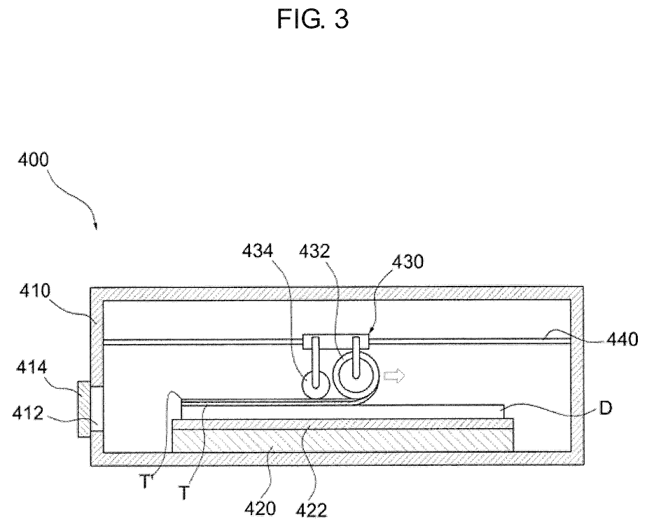

Referring to FIG. 3, the laminating device 400 may include a laminating chamber 410 which defines therein a laminating space in which the adhesive film T may be applied. The laminating device 400 may also include an opening 412 through which the display panel D may be introduced into the laminating space, a laminating stage 420 disposed at a lower portion of the laminating chamber 410 to allow the display panel D to be seated thereon, an adhesive film laminating device 430 installed above the laminating stage 420 which may reciprocate to laminate the adhesive film T on a portion of or on the entire attachment surface of the display panel D, and guide rails 440 which guide the adhesive film laminating device 430 in a reciprocating manner in the laminating chamber 410.

A separate laminating door 414 may be provided at the opening 412 so as to close the laminating space. A laminating stage fastening device 422 may be provided with the laminating stage 420 to fasten the display panel D seated on the laminating stage 420. The laminating stage fastening device 422 may be, for example, an electrostatic chuck that uses electrostatic force, a suction chuck that uses vacuum suction force, or other device as appropriate. The adhesive film laminating device 430 may include an adhesive film bobbin 432 which supplies adhesive film T, wound thereon, to the attachment surface of the display panel D, and a pressing roller 434 which presses and laminates the supplied adhesive film T onto the attachment surface of the display panel D.

In certain embodiments, a release film T′ may be provided on an unattached surface of the adhesive film T facing away from the surface thereof which adheres to the attachment surface of the display panel D, to protect the unattached surface while laminating the adhesive film T, and in particular, while pressing the adhesive film T with the pressing roller 434. The release film T′ may be removed through a separate process after lamination of the adhesive film T is completed, to allow the display panel D and the stereoscopic lens panel P to be subsequently attached with each other.

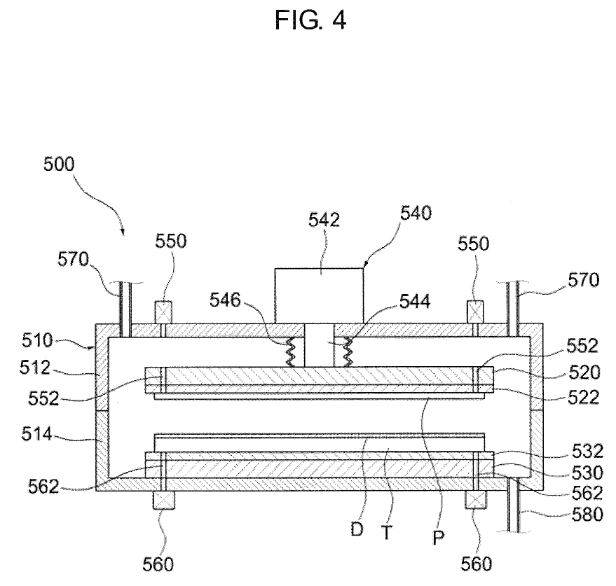

The panel attachment device 500 may attach the display panel D and the stereoscopic lens panel P to each other. Referring to FIG. 4, the panel attachment device 500 may include an attaching chamber 510 which defines an attaching space therein, an upper stage 520 disposed adjacent to an upper portion of the attaching chamber 510 in such a way as to be raised and lowered, a lower stage 530 disposed at a lower portion of the attaching chamber 510, and a raising and lowering device 540 which raises and lowers the upper stage 520 with respect to the lower stage 530.

The attaching chamber 510 may include an upper chamber 512 and a lower chamber 514 which can be separated from each other. Accordingly, with the upper chamber 512 and the lower chamber 514 separated from each other, the display panel D and the stereoscopic lens panel P may be introduced into the attaching space or the attached stereoscopic display panel DP may be discharged out of the attaching space.

The upper stage 520 may be suspended from an inner surface of the upper chamber 512 and may be supported, raised and lowered by the raising and lowering device 540. A stereoscopic lens panel fastening device 522, to which the stereoscopic lens panel P is fastened, may be provided on the lower surface of the upper stage 520. The stereoscopic lens panel fastening device 522 may be, for example, an electrostatic chuck that uses electrostatic force, a suction chuck that uses vacuum suction force, or other device as appropriate. A display panel fastening device 532 may be provided on the upper surface of the lower stage 530. The display panel fastening device 532 may be, for example, an electrostatic chuck that uses electrostatic force, a suction chuck that uses vacuum suction force, or other device as appropriate.

The raising and lowering device 540 may be arranged on the upper chamber 512 and connected with the upper stage 520. The raising and lowering device 540 may raise and lower the upper stage 520 with respect to the lower stage 530. The raising and lowering device 540 may include a raising and lowering body 542 which raises and lowers the upper stage 520, a raising and lowering shaft 544 which connects the raising and lowering body 542 with the upper stage 520, and a bellows 546 which surrounds the raising and lowering shaft 544 to maintain airtightness of the upper chamber 512.

Although in the embodiment shown in FIG. 4 the raising and lowering device 540 is coupled to the upper stage 520 to raise and lower the upper stage 520 with respect to the lower stage 530, in alternative embodiments the raising and lowering device 540 may be coupled to the lower stage 530 to raise and lower the lower stage 530 with respect to the upper stage 520.

Alignment cameras 550 may be installed on the upper chamber 512 facing an interior space of the upper chamber 512, and illuminators 560 may be installed on the lower chamber 514 facing the alignment cameras 550. The illuminators 560 may serve as light sources for image-sensing of alignment marks (not shown) provided on the display panel D and the stereoscopic lens panel P. The alignment cameras 550 may image-sense the alignment marks provided on the display panel D and the stereoscopic lens panel P such that alignment between the display panel D and the stereoscopic lens panel P may be adjusted. When the alignment cameras 550 and the illuminators 560 are employed, image-sensing holes 552 may be defined through the upper stage 520, and illumination holes 562 may be defined through the lower stage 530.

Outlet pipes 570 and inlet pipes 580 may be connected to the attaching chamber 510 such that an attachment environment may be formed in the attaching space defined by the attaching chamber 510. The outlet pipes 570 may be connected with a pump (not shown) after the display panel D and the stereoscopic lens panel P are introduced into the attaching chamber 510, to maintain the attaching space in a vacuum state. The inlet pipes 580 may be connected with a gas supply source (not shown) after the stereoscopic lens panel P is adhered to the display panel D, to supply a gas into the attaching space so as to pressurize at least one of the display panel D and the stereoscopic lens panel P and facilitate attachment therebetween. In certain embodiments, nitrogen (N2) gas may be used.

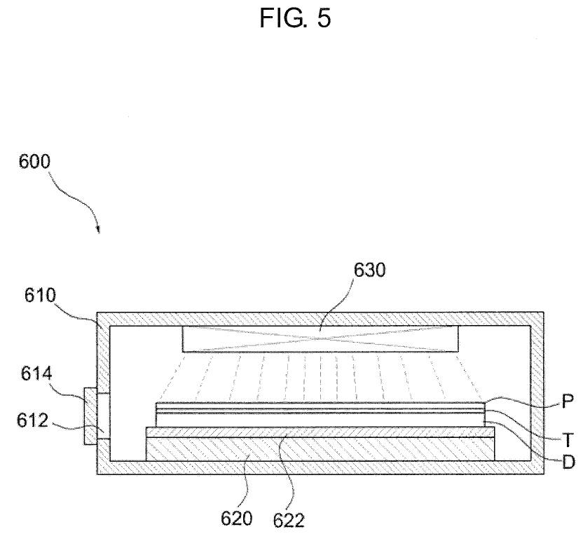

The baking device 600 may bake the adhesive film T which adheres between the display panel D and the stereoscopic lens panel P. Referring to FIG. 5, the baking device 600 may include a baking chamber 610 which defines therein a baking space for baking the adhesive film T, with an opening 612 for allowing the attached stereoscopic display panel DP to be introduced into the baking space therethrough, a baking stage 620 disposed at a lower portion of the baking chamber 610 to allow the stereoscopic display panel DP to be seated thereon, and a baking module 630 fastened to an upper portion of the baking chamber 610 to radiate ultraviolet rays onto the adhesive film T.

A separate baking door 614 may be provided at the opening 612 so as to close the baking space. A baking stage fastening device 622 may be included to fasten the display panel DP on the baking stage 620. The baking stage fastening device 622 may be, for example, an electrostatic chuck that uses electrostatic force, a suction chuck that uses vacuum suction force, or other device as appropriate.

The baking module 630 may be supported by a raising and lowering device (not shown) such that it may be raised and lowered with respect to the baking stage 620. Due to the presence of this raising and lowering device, by changing the distance between the baking module 630 and the display panel DP seated on the baking stage 620, the baking degree of the display panel DP may be adjusted.

The panel discharge device 700 may temporarily receive the attached stereoscopic display panel DP before further processing of the display panel DP is conducted. The panel discharge device 700 may include a plurality of discharge loading devices 710 that receive display panels DP. Insertion grooves 720 that receive the conveyance device 200 may be defined on the upper surface of each discharge loading device 710. The numbers of the panel discharge device 700 and the discharge loading devices 710 may be increased or decreased based on the scale of the attachment system 10.

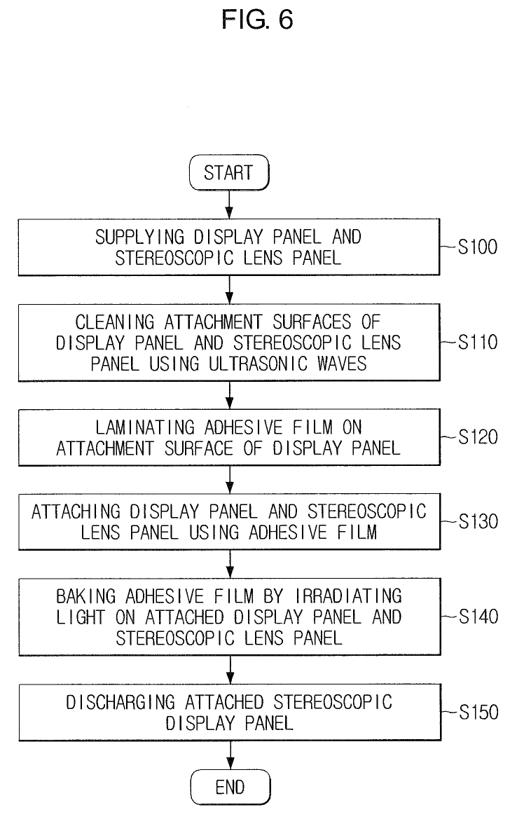

Operation of a system for attaching a display panel that displays a stereoscopic image as embodied and broadly described herein will be discussed with reference to FIGS. 6 through 10.

First, the display panel D and the stereoscopic lens panel P, which are substantially completely manufactured through separate processes prior to being provided to the system 10, are seated on the panel supply device 100 by a separate external conveyance device (not shown).

The display panel D and the stereoscopic lens panel P seated on the panel supply device 100 are sequentially conveyed to the cleaning device 300 by the conveyance device 200. At this time, the fork 238 of the conveyance device 200 is inserted into the insertion grooves 120 of the panel supply device 100 through the actuation of the rotating part 234 and the raising and lowering shaft. In this state, the conveyance device 200 raises the display panel D or the stereoscopic lens panel P seated on the loading device 110, moves along the rails 210, and conveys the display panel D or the stereoscopic lens panel P to the cleaning device 300 (S100).

Thereafter, the respective attachment surfaces of the display panel D and the stereoscopic lens panel P conveyed to the cleaning device 300 are cleaned by the ultrasonic cleaning device 330 (S110) (see FIG. 2). The procedure for cleaning the display panel D and the stereoscopic lens panel P is as described below.

As the display panel D is introduced into the cleaning chamber 310 through the opening 312 by the conveyance device 200, the display panel D is seated on the cleaning stage 320 and is fastened to the cleaning stage 320 by the cleaning stage fastening device 322. Then, the opening 312 is closed by the actuation of the cleaning door 314, and the ultrasonic cleaning unit 330 is moved along the guide rails 340 and conducts the cleaning process for the display panel D.

At this time, the ultrasonic cleaning unit 330 is moved while cleaning liquid is injected onto the attachment surface of the display panel D by the cleaning liquid injector 332, and the ultrasonic scanner 334 performs ultrasonic cleaning by scanning the attachment surface of the display panel D, to which the cleaning liquid has been applied, with ultrasonic waves. The cleaning of the stereoscopic lens panel P may be carried out through substantially the same procedure as the cleaning of the display panel D described above.

Once having completed the cleaning process, the display panel D and the stereoscopic lens panel P are discharged from the cleaning chamber 310 and are conveyed to the laminating device 400 by the conveyance device 200, and the adhesive film T is laminated on the attachment surface of the display panel D (S120) (see FIG. 3). While in the embodiment shown in FIG. 3, the adhesive film T is laminated on the attachment surface of the display panel D, in alternative embodiments the adhesive film T may be laminated onto the attachment surface of the stereoscopic lens panel P.

As the display panel D is introduced into the laminating chamber 410 through the opening 412 by the actuation of the conveyance device 200, the display panel D is seated on the laminating stage 420 and is fastened by the laminating stage fastening device 422. Next, the opening 412 is closed by the actuation of the laminating door 414, and the laminating space is defined in the laminating chamber 410. The adhesive film laminating device 430 is moved along the guide rails 440 and laminates the adhesive film T on the attachment surface of the display panel D.

As the adhesive film T, which is wound on the adhesive film bobbin 432, is paid out, the adhesive film T is pressed by the pressing roller 434 and is laminated onto the attachment surface of the display panel D. The release film T′ attached to the adhesive film T is released from the adhesive film T through a separate process.

Although the laminating procedure described above was carried out on the attachment surface of the display panel D, in alternative embodiments, substantially the same procedure may be carried out on the attachment surface of the stereoscopic lens panel P. After the laminating process is completed, the display panel D having the adhesive film T laminated thereon is discharged from the laminating chamber 410 and is conveyed to the panel attachment device 500 by the conveyance device 200.

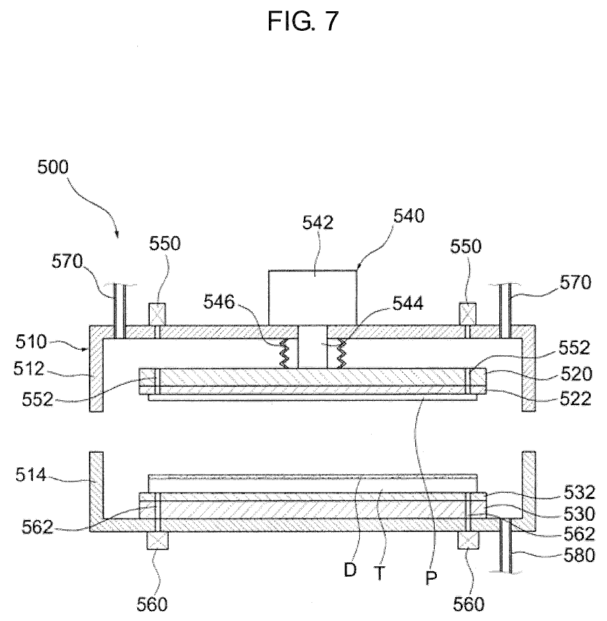

The stereoscopic lens panel P having undergone the cleaning process and the display panel D having the adhesive film T laminated thereon are sequentially conveyed by the conveyance device 200, are introduced into the panel attachment device 500, and are attached with each other (S130). The procedure in the panel attachment device 500 will be described below in detail with reference to FIGS. 7 through 10.

Referring to FIG. 7, the display panel D and the stereoscopic lens panel P conveyed by the conveyance device 200 are moved into the space between the upper chamber 512 and the lower chamber 514 which, at this point, are separated from each other. At this time, the display panel D is fastened by the display panel fastening device 532 provided on the lower stage 530, and the stereoscopic lens panel P is fastened by the stereoscopic lens panel fastening device 522 provided on the upper stage 520.

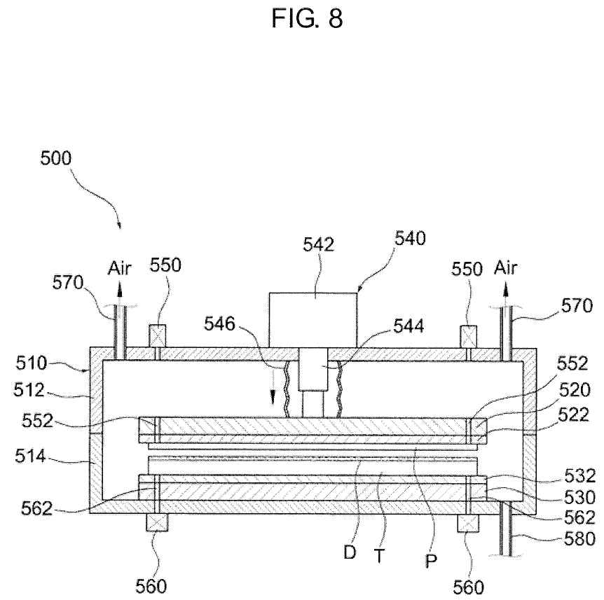

Referring to FIG. 8, after the display panel D and the stereoscopic lens panel P are fastened, the upper and lower chambers 512 and 514 and moved towards each other, and as the upper chamber 512 and the lower chamber 514 are coupled to each other, the attaching space is defined. Then, air in the attaching space is discharged through the outlet pipes 570, and an attachment environment (a vacuum condition) is created in the attaching space.

After the attachment environment is created, as the upper stage 520 is lowered by the raising and lowering device 540, the display panel D and the stereoscopic lens panel P are positioned relative to each other so as to have a gap formed therebetween that is appropriate for attachment. At this time, the attachment positions of the display panel D and the stereoscopic lens panel P are adjusted based on the alignment marks on the respective panels D and P sensed by the alignment cameras 550.

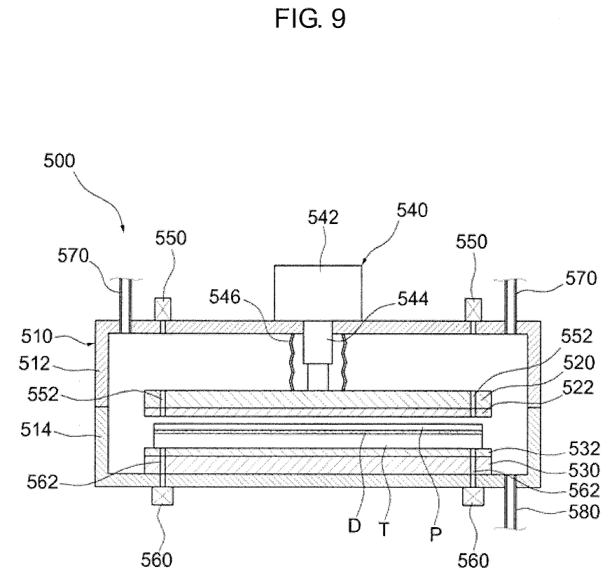

With the display panel D and the stereoscopic lens panel P completely aligned in this way, as shown in FIG. 9, the stereoscopic lens panel P fastened to the upper stage 520 is unfastened and drops onto the adhesive film T of the display panel D seated on the lower stage 530, and the display panel D and the stereoscopic lens panel P come into contact with each other.

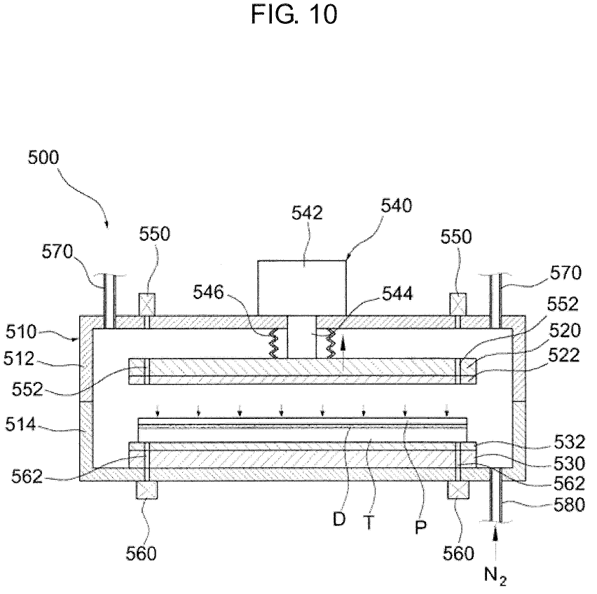

After the stereoscopic lens panel P comes into contact with the display panel D in this way, gas is supplied into the attaching space. As the gas is being supplied into the attaching space through the inlet pipes 580, the stereoscopic lens panel P is pressurized against the display panel D due to pressure induced in the attaching space, and the stereoscopic lens panel P is attached to the display panel D by the medium of the adhesive film T (see FIG. 10).

After the display panel D and the stereoscopic lens panel P are attached with each other, the upper chamber 512 and the lower chamber 514 of the panel attachment device 500 are separated from each other to open the attaching space, and the display panel D and the stereoscopic lens panel P, which are now attached to each other, are picked up by the conveyance device 200 and are conveyed to the baking device 600.

The resultant stereoscopic display panel DP obtained through the attachment process performed in the panel attachment device 500 is conveyed to the baking device 600. The adhesive film T interposed between the display panel D and the stereoscopic lens panel P is baked by the ultraviolet rays radiated from the baking device 600 (S140) (see FIG. 5).

More specifically, the stereoscopic display panel DP is introduced into the baking chamber 610 through the opening 612 by the conveyance device 200, and the stereoscopic display panel DP is seated on the baking stage 620 and is fastened by the baking stage fastening device 622. Then, as the opening 612 is closed by the actuation of the baking door 614, the baking space is defined in the baking chamber 610, ultraviolet rays are radiated to the adhesive film T by actuating the baking module 630, and the adhesive film T is baked.

The stereoscopic display panel DP having completely undergone the baking process is taken out of the baking chamber 610 by the conveyance device 200 and is loaded onto the panel discharge device 700, whereby the processes for attaching the display panel D and the stereoscopic lens panel P to form a stereoscopic display panel DP is completed (S150).

In a system for attaching a display panel D and a stereoscopic lens panel P to form a stereoscopic display panel DP as embodied and broadly described herein, due to the efficient arrangement and management of respective equipments, the productivity may be increased.

Also, in a system as embodied and broadly described herein, a display panel and a stereoscopic lens panel may be attached through a laminating process, and thus defects occurring during attachment of the display panel with the stereoscopic lens panel may be minimized.

In a system for attaching a display panel for stereoscopic image as embodied and broadly described herein the locations of chambers for attaching a display panel and a stereoscopic lens panel are determined in a manner such that the display panel and the stereoscopic lens panel can be attached at precise positions.

In a system for attaching a display panel for stereoscopic image as embodied and broadly described herein, a display panel for stereoscopic image may be attached by laminating an adhesive film on the entire attachment surface of a display panel through a laminating process and then attaching the display panel and a stereoscopic lens panel, thereby improving the quality of the display panel for stereoscopic image.

A system for attaching a display panel for stereoscopic image as embodied and broadly described herein may include a panel supply device for loading thereon a display panel and a stereoscopic lens panel; a conveyance device for conveying the display panel and the stereoscopic lens panel; a cleaning device for cleaning attachment surfaces of the display panel and the stereoscopic lens panel; a laminating device for laminating an adhesive film on either of the attachment surfaces which are cleaned by the cleaning device; a panel attachment device for attaching the display panel and the stereoscopic lens panel either of which is laminated with the adhesive film by the laminating device; a baking device for baking the adhesive film which is interposed between the display panel and the stereoscopic lens panel attached with each other; and a panel discharge device for loading thereon a display panel for stereoscopic image which has the adhesive film baked by the baking device, for subsequent processing.

In certain embodiments, the conveyance device may include rails laid to extend between the devices; a base reciprocatably moved along the rails; and a conveying arm installed on the base and moved integrally with the base to support lower surfaces of the display panel, the stereoscopic lens panel, and the display panel for stereoscopic image.

In certain embodiments, the conveying arm may include a raising and lowering shaft installed on the base; a rotating part provided on the raising and lowering shaft to be raised and lowered; a plurality of pivot links pivotably installed on the rotating part; and forks joined to ends of the pivot links to support the lower surfaces of the respective panels.

In certain embodiments, the cleaning device may include a cleaning chamber defining a cleaning space in which the display panel or the stereoscopic lens panel is introduced; a cleaning stage disposed on a bottom of the cleaning chamber to allow the display panel or the stereoscopic lens panel introduced into the cleaning space to be seated thereon; an ultrasonic cleaning unit reciprocatably installed above the cleaning stage to clean the attachment surface of the display panel or the stereoscopic lens panel seated on the cleaning stage; and guide rails guiding reciprocating movement of the ultrasonic cleaning unit over the attachment surface.

In certain embodiments, the cleaning chamber may include an opening for introducing the display panel or the stereoscopic lens panel; and a cleaning door for closing the opening.

In certain embodiments, the ultrasonic cleaning unit may include a cleaning liquid injector for forming a cleaning layer on the attachment surface of the display panel or the stereoscopic lens panel seated on the cleaning stage; an ultrasonic scanner for applying ultrasonic vibrations to the cleaning layer; and an ultrasonic vibrator for generating ultrasonic waves in the ultrasonic scanner.

In certain embodiments, the laminating device may include a laminating chamber defining a laminating space for laminating the adhesive film; a laminating stage disposed on a bottom of the laminating chamber to allow the display panel or the stereoscopic lens panel introduced into the laminating space to be seated thereon; an adhesive film laminating unit reciprocatably installed above the laminating stage to laminate the adhesive film on the entire attachment surface of the display panel or the stereoscopic lens panel seated on the laminating stage; and guide rails guiding reciprocating movement of the adhesive film laminating unit over an upper surface of the laminating stage.

In certain embodiments, the laminating chamber may include an opening for introducing the display panel or the stereoscopic lens panel; and a laminating door for closing the opening.

In certain embodiments, the adhesive film laminating unit may include an adhesive film bobbin supplying the adhesive film to the attachment surface; and a pressing roller pressing and laminating the adhesive film supplied to the attachment surface.

In certain embodiments, a release film is provided to the other surface of the adhesive film facing away from one surface thereof which adheres to the attachment surface, to protect the other surface while laminating the adhesive film.

In certain embodiments, the panel attachment device may include a chamber defining an attaching space for attaching the display panel and the stereoscopic lens panel; an upper stage disposed adjacent to a top of the chamber in such a way as to be raised and lowered; a raising and lowering unit raising and lowering the upper stage; and a lower stage disposed on a bottom of the chamber.

In certain embodiments, the chamber may include alignment cameras for image-sensing alignment marks formed on the display panel and the stereoscopic lens panel; and illuminators for providing illumination to allow the alignment cameras to image-sense the alignment marks.

In certain embodiments, the raising and lowering unit may include a raising and lowering body for raising and lowering the upper stage; a raising and lowering shaft connecting the raising and lowering body with the upper stage; and bellows placed around the raising and lowering shaft and maintaining airtightness of the chamber.

In certain embodiments, the chamber may include outlet pipes for maintaining the attaching space under a vacuum state; and inlet pipes for supplying a gas into the attaching space so as to ensure attachment of the display panel and the stereoscopic lens panel.

In certain embodiments, the baking device may include a baking chamber defining a baking space for baking the adhesive film; a baking stage disposed on a bottom of the baking chamber to allow the display panel for stereoscopic image introduced into the baking space to be seated thereon; and a baking module fastened to a top of the baking chamber to radiate ultraviolet rays to the display panel for stereoscopic image seated on the baking stage so as to bake the adhesive film.

In certain embodiments, the baking chamber may include an opening for introducing the display panel for stereoscopic image; and a baking door for closing the opening.

Any reference in this specification to “one embodiment,” “an embodiment,” “example embodiment,” “certain embodiment,” “alternative embodiment” etc., means that a particular feature, structure, or characteristic described in connection with the embodiment is included in at least one embodiment as broadly described herein. The appearances of such phrases in various places in the specification are not necessarily all referring to the same embodiment. Further, when a particular feature, structure, or characteristic is described in connection with any embodiment, it is submitted that it is within the purview of one skilled in the art to affect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, numerous variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A system for attaching display panels, comprising:
a panel supply device that receives a display panel and a stereoscopic lens panel;
a conveyance device that conveys the display panel and the stereoscopic lens panel amongst a plurality of devices of the system, the plurality of devices including:
a cleaning device that cleans respective attachment surfaces of the display panel and the stereoscopic lens panel;
a laminating device that applies an adhesive film to one of the display panel attachment surface or the stereoscopic lens panel attachment surface;
a panel attachment device that attaches the display panel and the stereoscopic lens panel with the adhesive film positioned therebetween to form a stereoscopic image panel;
a baking device that bakes the adhesive film positioned between the attached display panel and stereoscopic lens panel; and
a panel discharge device that receives the stereoscopic image panel including from the baking device for subsequent processing.

2. The system of claim 1, wherein the conveyance device comprises:
rails that extend between the plurality of devices;
a base that moves back and forth along the rails; and
a conveying arm installed on the base and that moves integrally with the base, wherein the conveying arm supports lower surfaces of the display panel, the stereoscopic lens panel, and the stereoscopic image panel.

3. The system of claim 2, wherein the conveying arm comprises:
a raising and lowering shaft installed on the base;
a rotating part provided on the raising and lowering shaft, wherein the rotating part is configured to be raised and lowered;
a plurality of pivot links pivotably installed on the rotating part; and
forks joined to respective ends of the plurality of pivot links, wherein the forks support the lower surfaces of the panels as the panels are supported and moved by the conveyance device.

4. The system of claim 1, wherein the cleaning device comprises:
a cleaning chamber that defines a cleaning space that receives the display panel and the stereoscopic lens panel;
a cleaning stage provided at a lower portion of the cleaning chamber, wherein the cleaning stage receives the display panel and the stereoscopic lens panel thereon;
an ultrasonic cleaning device provided above the cleaning stage, wherein the ultrasonic cleaning device cleans the attachment surface of the display panel and the stereoscopic lens panel received on the cleaning stage; and
guide rails that guide a reciprocal movement of the ultrasonic cleaning device over the attachment surface.

5. The system of claim 4, wherein the cleaning chamber comprises:
an opening through which the display panel and the stereoscopic lens panel are introduced into the cleaning chamber; and
a cleaning door that closes the opening.

6. The system of claim 4, wherein the ultrasonic cleaning device comprises:
a cleaning liquid nozzle that applies a cleaning layer on the attachment surface of the panel seated on the cleaning stage;
an ultrasonic scanner that applies ultrasonic vibrations to the cleaning layer; and
an ultrasonic vibrator that generates ultrasonic waves of the ultrasonic scanner.

7. The system of claim 1, wherein the laminating device comprises:
a laminating chamber that defines a laminating space therein;
a laminating stage provided at a lower portion of the laminating chamber, wherein the laminating stage receives the display panel or the stereoscopic lens panel to be laminated;
an adhesive film laminating device provided above the laminating stage, wherein the adhesive laminating device applies the adhesive film onto the attachment surface of the display panel or the stereoscopic lens panel received on the laminating stage; and
guide rails that guide a reciprocal movement of the adhesive film laminating device over an upper surface of the laminating stage.

8. The system of claim 7, wherein the laminating chamber comprises:
an opening through which the display panel or the stereoscopic lens panel is introduced into the laminating chamber; and
a laminating door that closes the opening.

9. The system of claim 7, wherein the adhesive film laminating device comprises:
an adhesive film bobbin that supplies adhesive film to the attachment surface; and
a pressing roller that presses and laminates the supplied adhesive film onto the attachment surface.

10. The system of claim 7, wherein the adhesive film comprises a first surface that is attached to the attachment surface, and a second surface opposite the first surface, wherein a release film is provided on the second surface of the adhesive film.

11. The system of claim 10, wherein the release film is removable from the adhesive film after the laminating process is complete.

12. The system of claim 1, wherein the panel attachment device comprises:
a chamber that defines an attaching space in which the display panel and the stereoscopic lens panel are attached;
an upper stage provided in an upper portion of the chamber so as to be raised and lowered;
a raising and lowering device that raises and lowers the upper stage; and
a lower stage provided in a lower portion of the chamber.

13. The system of claim 12, wherein the chamber comprises:
alignment cameras that detect alignment marks provided on the display panel and the stereoscopic lens panel; and
illuminators that illuminate the alignment marks for the detection by the alignment cameras.

14. The system of claim 12, wherein the raising and lowering device comprises:
a raising and lowering body that raises and lowers the upper stage;
a raising and lowering shaft that connects the raising and lowering body with the upper stage; and
bellows that surround the raising and lowering shaft so as to maintain airtightness of the chamber.

15. The system of claim 12, wherein the chamber comprises:
outlet pipes that maintain a vacuum state in the attaching space; and
inlet pipes that supply a pressurizing gas into the attaching space so as to attach the display panel and the stereoscopic lens panel.

16. The system of claim 1, wherein the baking device comprises:
a baking chamber that defines a baking space in which the adhesive film is baked;
a baking stage provided in a lower portion of the baking chamber to receive the stereoscopic image panel thereon; and
a baking module provided at an upper portion of the baking chamber to radiate ultraviolet rays onto the stereoscopic panel received on the baking stage so as to bake the adhesive film.

17. The system of claim 16, wherein the baking chamber comprises:
an opening through which stereoscopic image panel is introduced; and
a baking door that closes the opening.

18. A method of attaching a display panel and a stereoscopic lens panel to form a stereoscopic image panel, the method comprising:
providing a display panel and a stereoscopic lens panel to a supply device;
conveying the display panel and the stereoscopic lens panel to a cleaning device, and cleaning respective attachment surfaces of the display panel and the stereoscopic lens panel;
conveying one of the display panel or the stereoscopic lens panel to a laminating device, and applying an adhesive film onto the attachment surface thereof;
conveying the one of the display panel or the stereoscopic lens panel having the adhesive film applied thereto and the other of the display panel or the stereoscopic lens panel to an attachment device, and attaching the respective attachment surfaces of the display panel and the stereoscopic lens panel with the adhesive film positioned therebetween to form a stereoscopic image panel;
conveying the stereoscopic image panel to a baking device, and baking the adhesive film; and
conveying the stereoscopic image panel to a discharge device for discharge.

19. The method of claim 18, wherein applying an adhesive film comprises:
positioning the display panel on a laminating stage within a laminating chamber of the laminating device; and
pressing the adhesive film onto the attachment surface of the display panel.

20. The method of claim 19, wherein attaching the respective attachment surfaces of the display panel and the stereoscopic lens panel comprises:
positioning the display panel with the adhesive film applied thereto on a lower stage within an attaching chamber of the attaching device;
positioning the stereoscopic lens panel on an upper stage within the attaching chamber, with the attachment surface thereof facing the adhesive film applied on the attachment surface of the display panel;
moving the upper stage and lowering the stereoscopic lens panel onto the display panel; and
supplying a pressurizing gas to the attaching chamber to attach the display panel and the stereoscopic lens panel with the adhesive film positioned therebetween.

21. The method of claim 18, wherein cleaning respective attachment surfaces of the display panel and the stereoscopic lens panel comprises:
positioning the display panel and the stereoscopic lens panel on a cleaning stage provided in a cleaning chamber of the cleaning device with the respective attachment surfaces exposed;
spraying a cleaning fluid through a cleaning nozzle to form a cleaning layer on the attachment surfaces of the display panel and the stereoscopic lens panel;
moving an ultrasonic scanner long rails positioned above the cleaning stage, and applying ultrasonic vibrations to the cleaning layer to clean the attachment surfaces.
